(19) United States
(12) Patent Application Publication
(10) Pub. No.: US 2005/0157728 A1
(43) Pub. Date: Jul. 21, 2005

(54) Packet relay device

(76) Inventors: Marika Kawano, Yokohama (JP); Yushi Murata, Yokohama (JP); Takeshi Miyaura, Yokohama (JP); Mitsukuni Yoshida, Yokohama (JP); Shigeru Kotabe, Yokohama (JP)

Correspondence Address: KATTEN MUCHIN ROSENMAN LLP, 575 MADISON AVENUE, NEW YORK, NY, 10022-2585, US

(21) Appl. No.: 10/861,248

(22) Filed: Jun. 4, 2004

(30) Foreign Application Priority Data
Jan. 15, 2004 (JP) 2004-007473

(51) Int. Cl. H04L 12/28

(52) U.S. Cl. 370/395.21

(57) ABSTRACT

A packet relay device which realizes a QoS service with higher quality by improving an intra-device policy concerning packet discard. An input-side policing unit measures a first data rate of packets before being switched, and discards at least one of the packets before being switched, when the first data rate exceeds a first bandwidth value which is preset. A switching unit performs switching of the packets on which the input processing is performed. An output-side policing unit receives packets flowing together after being switched, measures a second data rate of a portion of the received packets corresponding to each value of a parameter, compares the second data rate with a second bandwidth value which is preset to be guaranteed for the value of the parameter, and discards at least one packet in the portion of the received packets when the second data rate exceeds the second bandwidth value.

### CROSS-REFERENCE TO RELATED APPLICATIONS

This application is based upon and claims the benefits of priority from the prior Japanese Patent Application No. 2004-007473, filed on Jan. 15, 2004, the entire contents of which are incorporated herein by reference.

### BACKGROUND OF THE INVENTION

1) Field of the Invention

The present invention relates to a packet relay device for relaying packets while guaranteeing QoS (quality of service).

2) Description of the Related Art

Currently, information and communication networks are constructed in various forms, and are providing various services. For example, wide-area Ethernet services are carrier services which utilize LANs (local area networks) and the use of which is widely spreading. (Ethernet is a registered trademark.)

In the wide-area Ethernet services, a plurality of LAN environments each using the Ethernet are integrated by connecting the plurality of LAN environments to a network through Layer 2 switches. Since the wide-area Ethernets use switching hubs (Layer 2 switches) instead of routers (Layer 3 switches), and the Layer 2 switches are less expensive than the Layer 3 switches, it is possible to reduce the cost of construction and management of the wide-area Ethernet services. For example, it is possible to construct a MAN (metropolitan area network) by connecting in-company LANs so as to extend the in-company LANs to the entire metropolitan area. Regarding security, privacy can be guaranteed by using the VLAN (virtual LAN) technology. In the VLANs, it is possible to set virtual groups of terminals independently of the forms of physical connections.

In addition, in the conventional wide-area Ethernet services, best-effort type services are generally provided, where communication bandwidths are not guaranteed. However, in recent years, demands for QoS services, in which contracted bandwidths are guaranteed, are increasing.

One of the key techniques for realizing the QoS services is the policing performed in packet relay devices. The policing is a function for monitoring a packet flow rate, and adjusting the packet flow rate within a preset bandwidth by discarding overflow packets when the packet flow rate exceeds a predetermined bandwidth.

FIG. 9 is a diagram illustrating a construction of a conventional packet relay device. The packet relay device 100 comprises input units 110-1 to 110-n, a switching unit 120, and output units 130-1 to 130-n. The input units 110-1 to 110-n contain policing units 111-1 to 111-n, respectively.

Each of the input units 110-1 to 110-n performs processing for search for destinations of packets, classification of flows, and the like. In addition, each of the policing units 111-1 to 111-n measures the packet data rate, and adjusts the packet data rate by performing appropriate discard processing when the packet data rate exceeds a preset value.

The switching unit 120 performs processing for switching packets, and transfers the packets to predetermined ones of the output units 130-1 to-130-n. The output units 130-1 to 130-n perform queueing of the transferred packets and output processing of the packets based on priorities.

On the other hand, in a conventional packet QoS technique using policing, nodes for relaying packet are connected in series, where each of the nodes comprises an input unit, a switching unit, and an output unit, and the input unit in the leading one of the nodes polices packets, and performs QoS control. For example, see Japanese Unexamined Patent Publication No. 2002-354022, paragraph Nos. 0031 to 0049 and FIG. 1.

In the conventional packet relay device 100 illustrated in FIG. 9 and explained above, the input units 110-1 to 110-n adjust the packet data rate by policing the packets, but the output units 130-1 to 130-n do not police packets. Therefore, switched packets concentrate in one of the output units 130-1 to 130-n so that the data rate of the switched packets entering the output unit exceeds an output bandwidth. In this case, the packets overflows a queue arranged in the output unit, and the quality of transmission deteriorates.

In order to prevent occurrence of the above problem, conventionally, a back pressure (instruction to stop transmission) against a corresponding communication flow (an end-to-end flow of packets to be transferred between applications) is supplied to all of the input units 110-1 to 110-n before the queues overflow so that the input units 110-1 to 110-n discard packets in the corresponding communication flow by flow control.

FIG. 10 is a diagram provided for explaining the conventional back pressure control for prevention of queue overflow, where flows of packets belonging to a communication flow A are indicated. In the example of FIG. 10, a communication flow A includes 50%, 30%, and 40% of allowable amount of data that can be stored in the queues arranged in the output unit 130-1, respectivery. Therefore, when the switch unit 120 output the communication flow A to the output unit 130-1, a class queue for the communication flow A in the output unit 130-1 overflows with data. In this case, the output unit 130-1 provides a back pressure against the communication flow A to all of the input units 110-1 to 110-n so as to make the input units 110-1 to 110-n discard packets in the communication flow A.

Since the output unit 130-1 receives the switched communication flow A, and detects whether or not the class queue overflows, as explained above, the back pressure is supplied to all of the input units 110-1 to 110-n, which are arranged in the stage preceding the switching unit 120.

However, according to the above control for preventing queue overflow by use of the back pressure, the function of outputting the back pressure is activated based on the total sum of the data rates of packets outputted from the switching unit 120, not the individual data rates of packets outputted from the respective input units 110-1 to 110-n. Therefore, inequity occurs. That is, even when a great difference occurs between the data rates of packets transferred from different input units, e.g., when the input unit 110-1 outputs packets in the communication flow A with a high data rate, and the input unit 110-2 outputs packets in the communication flow A with a low data rate, the same back pressure is imposed on both of the input units. Since packets are not discarded based on the priority or weight, it is impossible to provide a high-quality QoS service.

Further, since, in each node in the conventional technique disclosed in Japanese Unexamined Patent Publication No. 2002-354022, policing is performed in only the input units in the stage preceding the switching unit so as to adjust the data rates of transferred packets, there is a possibility that a problem similar to the above-mentioned problem occurs. Therefore, it is impossible to provide a high-quality QoS service.

### SUMMARY OF THE INVENTION

The present invention is made in view of the above problems, and the object of the present invention is to provide a packet relay device which realizes a QoS service having higher quality by improving an intra-device policy concerning packet discard.

In order to solve the aforementioned problem, according to the present invention, a packet relay device for relaying packets while guaranteeing QoS is provided. The packet relay device comprises an input unit which performs input processing of packets; an input-side policing unit which is included in the input unit, measures a first data rate of packets before being switched, and discards at least one of the packets before being switched, when the first data rate exceeds a first bandwidth value which is preset; a switching unit which performs switching of the packets on which the input processing is performed; an output unit which performs output processing of packets; and an output-side policing unit which is included in the output unit, receives packets flowing together after being switched, measures a second data rate of a portion of the received packets corresponding to each value of a parameter, compares the second data rate with a second bandwidth value which is preset to be guaranteed for the value of the parameter, and discards at least one packet in the portion of the received packets when the second data rate exceeds the second bandwidth value.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating the principle of an packet relay device according to the present invention;

FIG. 2 is a diagram illustrating a construction of a first portion of the packet relay device;

FIG. 3 is a diagram illustrating a construction of a second portion of the packet relay device;

FIG. 4 is a diagram indicating a format of a packet containing an intra-device header;

FIG. 5 is a diagram illustrating operations for policing performed for each input number;

FIG. 6 is a diagram illustrating operations for policing performed for each combination of the values of the input number and a flow number;

FIG. 7 is a diagram illustrating a method for obtaining the flow number;

FIG. 8 is a diagram illustrating a construction of a network realizing a wide-area LAN system;

FIG. 9 is a diagram illustrating a construction of a conventional packet relay device; and

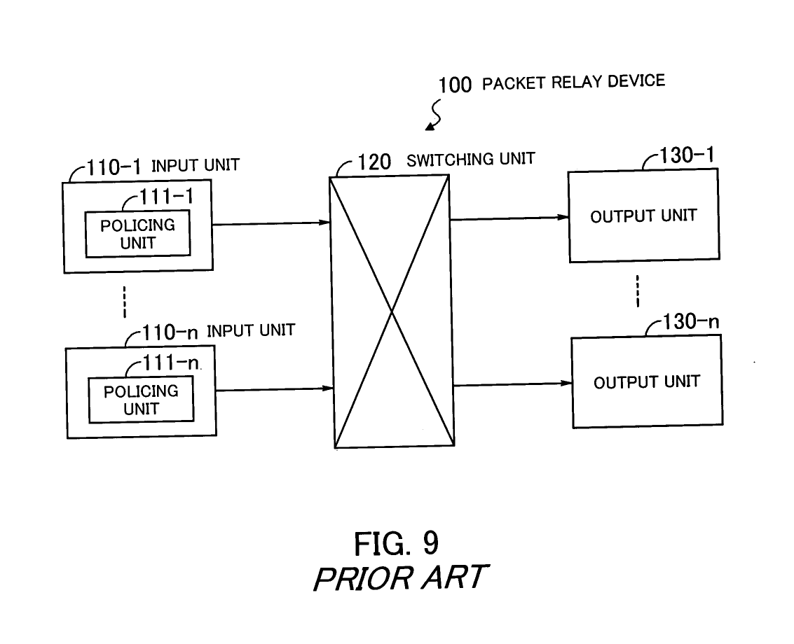

FIG. 10 is a diagram provided for explaining conventional back-pressure control for prevention of queue overflow.

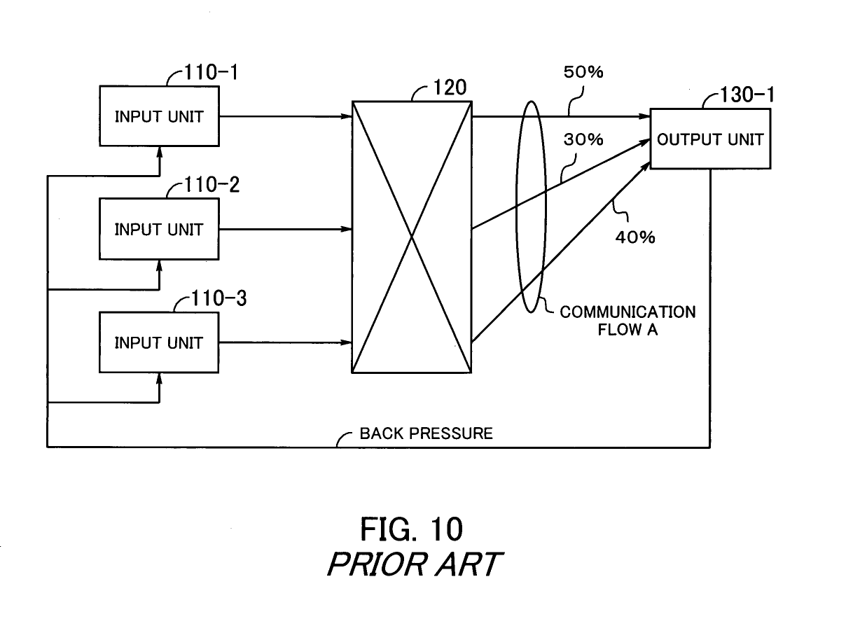

### DESCRIPTION OF THE PREFERRED EMBODIMENTS

Embodiments of the present invention are explained in detail below with reference to drawings.

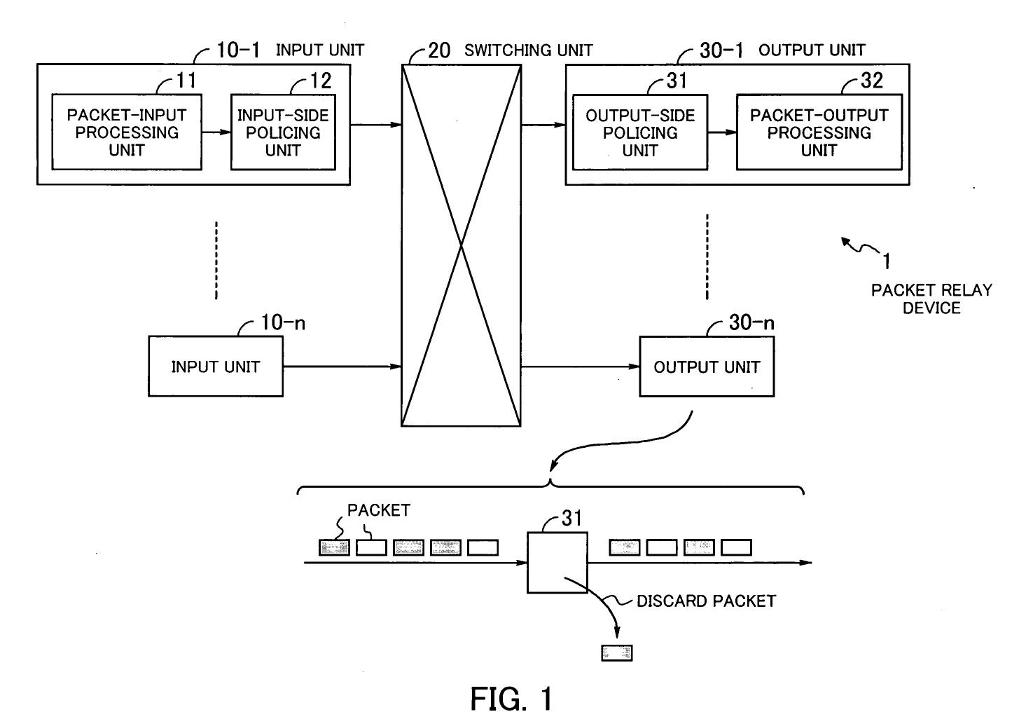

FIG. 1 is a diagram illustrating the principle of an packet relay device according to the present invention. The packet relay device 1 of FIG. 1 is a device for relaying packets while guaranteeing QoS, and comprises input units 10-1 to 10-n, a switching unit 20, and output units 30-1 to 30-n.

Each of the input units 10-1 to 10-n comprises a packet-input processing unit 11 and an input-side policing unit 12. The packet-input processing unit 11 performs overall packet-input processing of packets received from a network. The input-side policing unit 12 measures the data rate of packets before being switched, and discards at least one packet when the measured data rate exceeds a first bandwidth value which is preset. The switching unit 20 performs switching of the packets on which the input processing is performed.

Each of the output units 30-1 to 30-n comprises an output-side policing unit 31 and a packet-output processing unit 32. The output-side policing unit 31 receives packets which have been switched and then flow together, measures the data rate of a portion of the received packets corresponds to each value of a parameter, compares the data rate of the above portion with a second bandwidth value which is preset to be guaranteed for the value of the parameter, and discards at least one packet in the portion of the received packets when the second data rate exceeds the second bandwidth value. The packet-output processing unit 32 performs overall packet-output processing of the packets which have been policed after being switched.

As described above, according to the present invention, the output-side policing unit 31 is arranged in each of the output units 30-1 to 30-n for performing policing after the switching, as well as the policing performed in the input units 10-1 to 10-n for adjusting the data rates before the switching. Thus, even when packets after being switched concentrate in one of the output units 30-1 to 30-n, and the data rate of packets entering the output unit exceeds the output bandwidth, the bandwidth distribution is optimized.

That is, the bandwidth control based on the individual data rates is enabled according to the present invention, while conventionally a back pressure is supplied to all of the input units 10-1 to 10-n for making the input units 10-1 to 10-n discard packets. Therefore, it is possible to provide a QoS service with higher quality than that provided by the conventional technique.

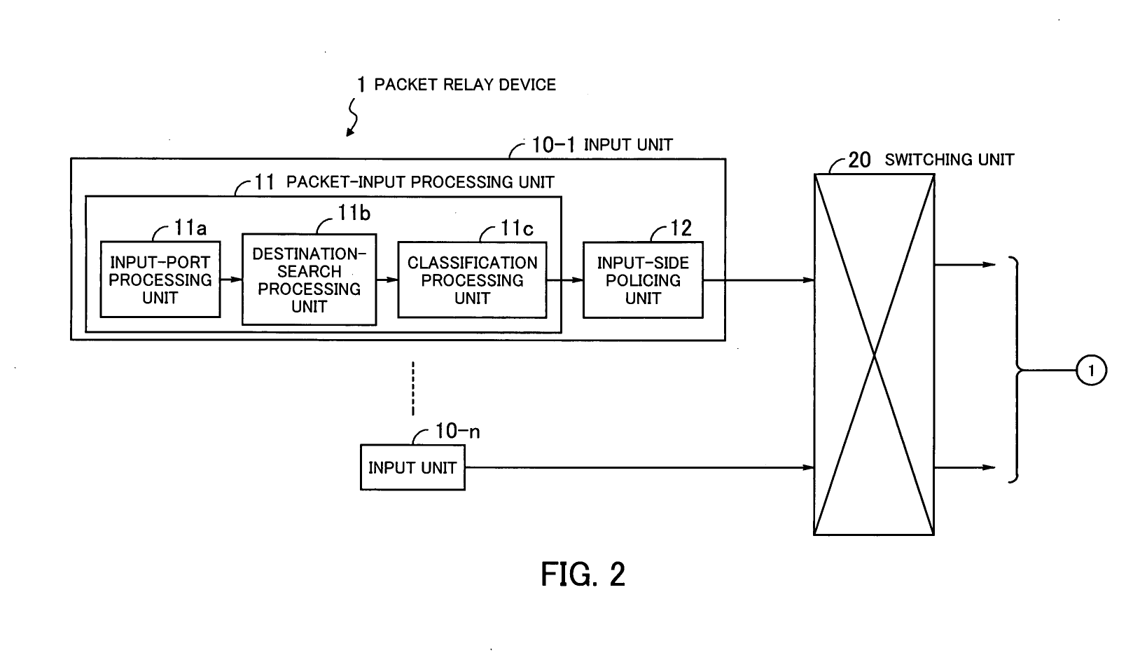

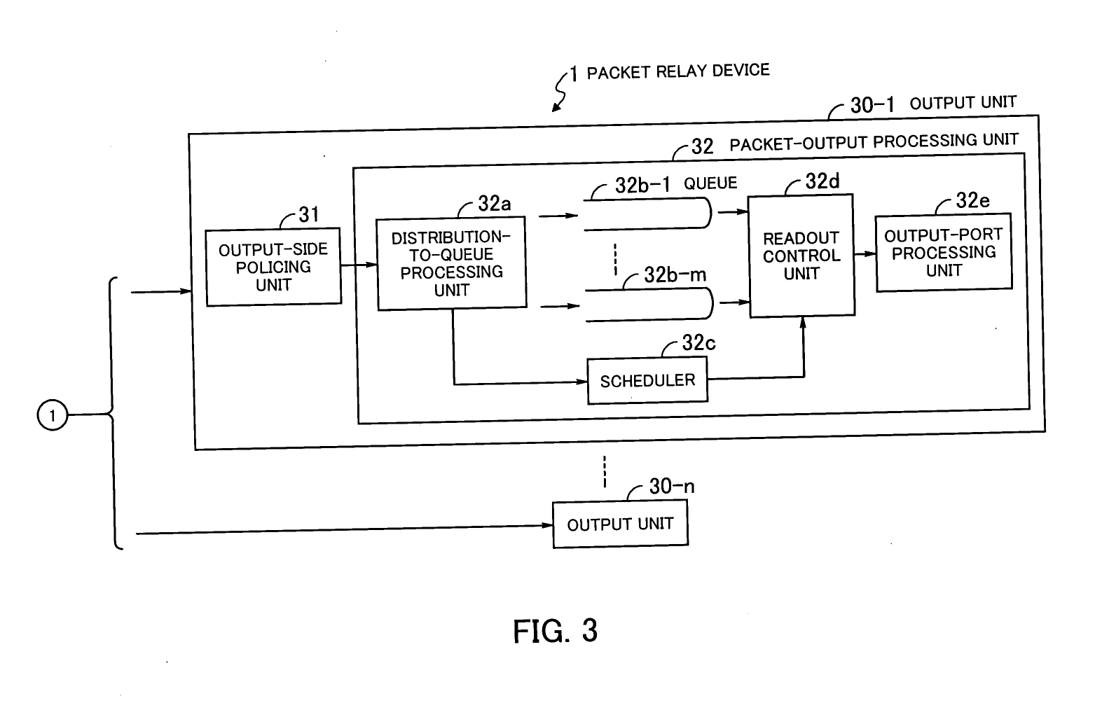

Next, details of the construction of the packet relay device 1 are explained below. FIGS. 2 and 3 are diagrams illustrating a construction of the first and second portions of the packet relay device. As described before, the packet relay device 1 comprises the input units 10-1 to 10-n, the switching unit 20, and output units 30-1 to 30-n. Each of the input units 10-1 to 10-n comprises the packet-input processing unit 11 and the input-side policing unit 12. Each of the output units 30-1 to 30-n comprises the output-side policing unit 31 and the packet-output processing unit 32.

Further, the packet-input processing unit 11 comprises an input-port processing unit 11a, a destination-search processing unit 11b, and a classification processing unit 11c, and the packet-output processing unit 32 comprises a distribution-to-queue processing unit 32a, queues 32b-1 to 32b-m, a scheduler 32c, a readout control unit 32d, and an output-port processing unit 32e.

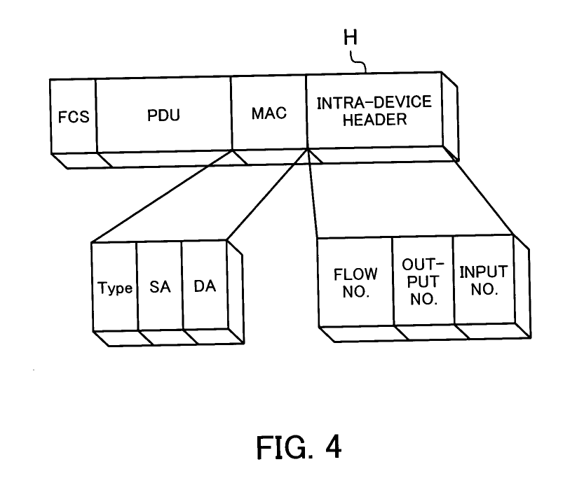

In each of the input units 10-1 to 10-n, the input-port processing unit 11a checks on the validity of each packet received from the network based on a frame check sequence (FCS) or the like. When the received packet is valid, the input-port processing unit 11a attaches to the received packet a physical port number as an intra-device header (modifies the received packet by attaching the physical port number to the received packet), and transfers the packet to the destination-search processing unit 11b. The intra-device header is a header containing information which is used only inside the packet relay device 1, and formats of a packet containing the intra-device header and the intra-device header per se are indicated in FIG. 4. Specifically, the physical port number is an identification number indicating one of the input units 10-1 to 10-n, and is hereinafter referred to as an input number. When the received packet is invalid, the input-port processing unit 11a discards the packet.

The destination-search processing unit 11b searches a table based on a MAC (media access control) address of the transferred packet, and obtains an identification number indicating one of the output units 30-1 to 30-n to which the packet is to be transferred. In the case of a VLAN, the table is searched based on a combination of a destination MAC address and a VLAN ID. Hereinafter, the identification number indicating one of the output units 30-1 to 30-n is referred to as an output number. Then, the destination-search processing unit 11b modifies the packet by inserting the output number in the intra-device header in the packet, and transfers the packet to the classification processing unit 11c.

The classification processing unit 11c compares predetermined elements (such as the input number and the output number in the intra-device header, the MAC address, a VLAN tag, and an IP address) in the transferred packet with reference elements which are preset for comparison, in order to determine which communication flow the transferred packet belongs to, and obtains a flow number corresponding to the determined communication flow. In addition, the classification processing unit 11c modifies the packet by inserting the flow number in the intra-device header, and transfers the packet to the input-side policing unit 12.

The input-side policing unit 12 measures a data rate of packets for each communication flow based on the flow number in the intra-device header in each packet, and compares the measured data rate with a data rate value which is preset. When the measured data rate exceeds the preset data rate value, the input-side policing unit 12 discards at least one excessive packet so as to adjust the data rate which passes through the input-side policing unit 12.

The switching unit 20 performs switching of packets by referring to the output number in the intra-device header in each packet processed by the input units 10-1 to 10-n, and transfers the packets to appropriate ones of the output units.

In the output units 30-1 to 30-n, the output-side policing unit 31 measures a data rate of packets for each value of a parameter, and compares the measured data rate with a bandwidth value which is preset to be guaranteed for the value of the parameter. When the measured data rate exceeds the bandwidth value preset for the above value of the parameter, the output-side policing unit 31 discards at least one excessive packet. Details of operations of the output-side policing unit 31 will be explained later.

The distribution-to-queue processing unit 32a refers to the flow number in the intra-device header in the transferred packet, and enqueues (stores) the data of the packet in one of queues 32b-1 to 32b-m corresponding to the class of the communication flow indicated by the flow number. Hereinafter, the queues 32b-1 to 32b-m are also referred to as class queues. When the enqueueing of each packet is completed, the distribution-to-queue processing unit 32a notifies the scheduler 32c of the completion.

The scheduler 32c receives the notification of the completion of the enqueueing in each queue from the distribution-to-queue processing unit 32a, and holds information on the number of packets enqueued in each of the class queues.

For example, the scheduler 32c can operate in accordance with a schedule algorithm which reads out data of packets from the class queues in descending order of the priorities of the class queues. The scheduler 32c selects a class queue having high priority based on the information on the number of packets enqueued in each of the class queues, sends to the readout control unit 32d a notification of packet readout from the selected class queue, and updates the information on the number of packets enqueued in the selected class queues by decrementing the number of packets enqueued in the selected class queue.

In response to the notification of packet readout from the selected class queue, the readout control unit 32d reads out data of at least one packet from the selected class queue, and transfers the at least one packet to the output-port processing unit 32e. At this time, the data of the at least one packet is read out so as to be appropriate to the output bandwidth to the network. The output-port processing unit 32e removes the entire intra-device header from the transferred packet, reformats the packet, and transmits the reformatted packet onto the network.

FIG. 4 is a diagram indicating a format of a packet containing an intra-device header. The packet format of FIG. 4 contains the intra-device header H. Initially, each packet entering the input units 10-1 to 10-n is constituted by an FCS (Frame check sequence), a PDU (protocol data unit), and a MAC address. The MAC address is constituted by a DA (destination address), an SA (source address), and a Type (Ethernet type). The intra-device header H is added by the processing performed in the input units 10-1 to 10-n. The intra-device header H contains an input number, an output number, and a flow number. When the packet relay processing is completed, and the output units 30-1 to 30-n output each packet, the intra-device header is removed from the packet.

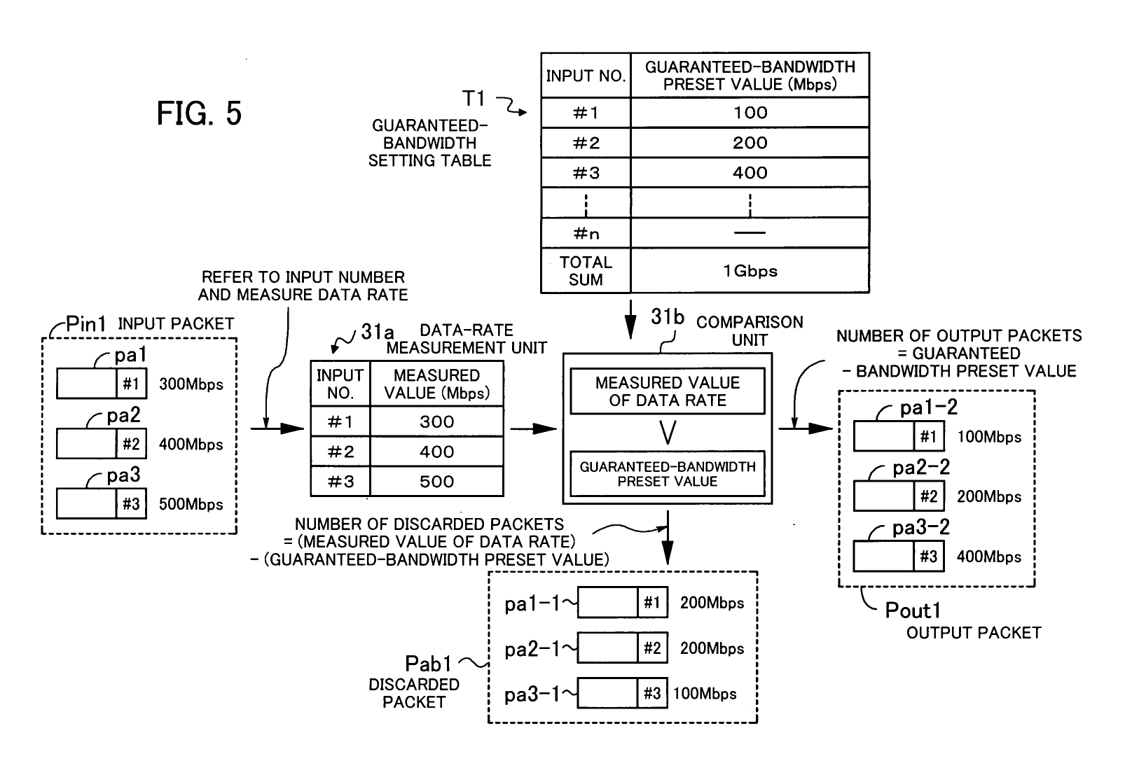

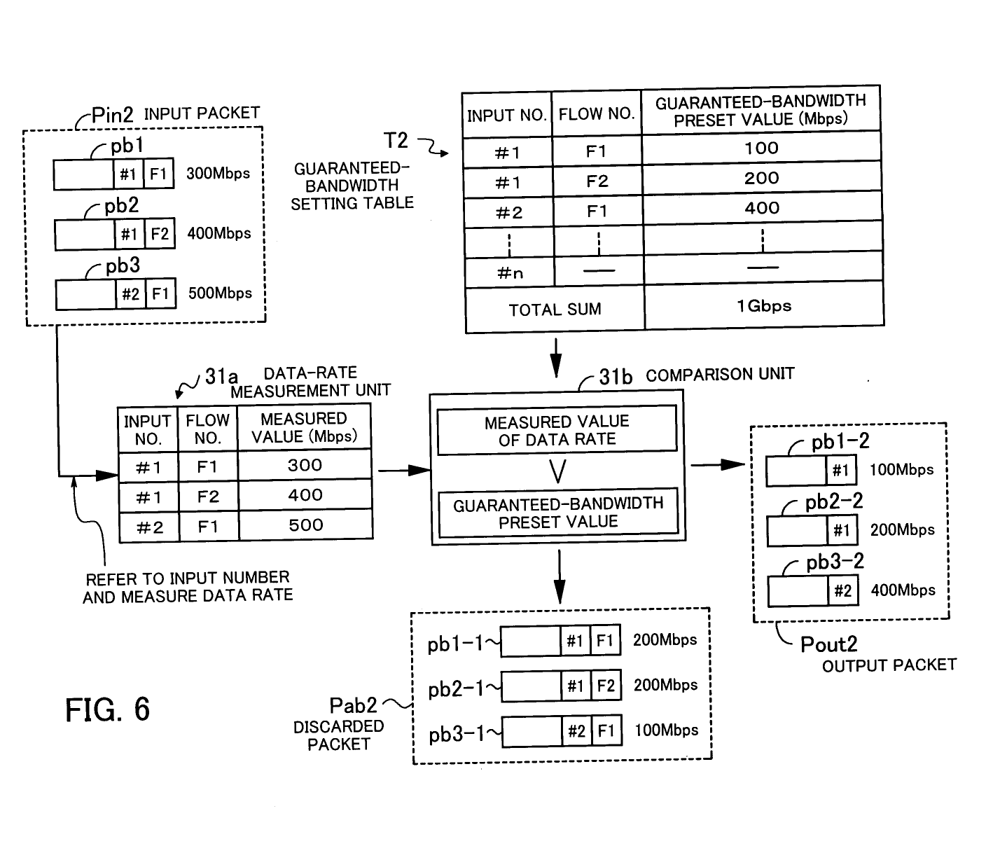

Next, details of the operations of the output-side policing unit 31 are explained below. As mentioned before, the output-side policing unit 31 measures the data rate of packets for each value of the parameter, and adjusts the data rate by comparing the measured value with the preset value. For example, the parameter may be realized by the physical port number (input number), the flow number, or the combination of the input number and the flow number. Hereinbelow, operations in the case where the parameter is the input number are explained with reference to FIG. 5, and operations in the case where the parameter is realized by the combination of the input number and the flow number are explained with reference to FIG. 6.

FIG. 5 is a diagram illustrating operations for policing performed for each input number. The output-side policing unit 31 comprises a data-rate measurement unit 31a, a comparison unit 31b, and a guaranteed-bandwidth setting table T1, and performs policing based on the input number as the parameter.

The input packets Pin1 are a group of packet flows which flow together and enter one of the output units after being switched by the switching unit 20. In this example, packet flows pa1, pa2, and pa3 respectively having bandwidths of 300, 400, and 500 Mbps enter the output unit, where an input number is contained in the intra-device header in each packet.

When the input packets Pin1 enter the output-side policing unit 31, the data-rate measurement unit 31a measures a data rate for each input number, and obtains the data rates of 300 Mbps from the packet flow pa1 corresponding to the input number “#1,” 400 Mbps from the packet flow pa2 corresponding to the input number “#2,” and 500 Mbps from the packet flow pa3 corresponding to the input number “#3.”

On the other hand, the guaranteed-bandwidth setting table T1 in the output-side policing unit 31 contains columns of the input number and the preset value of the guaranteed bandwidth (Mbps). For example, the guaranteed-bandwidth setting table T1 in FIG. 5 indicates that a bandwidth up to 100 Mbps is guaranteed for the packet flow corresponding to the input number “#1,” and the guaranteed total sum of the guaranteed bandwidths is 1 Gbps.

The comparison unit 31b compares the measured value of the data rate of the received packet flow corresponding to each input number with the guaranteed bandwidth value in the guaranteed-bandwidth setting table T1 corresponding to the input number. When the measured value is greater than the preset value, the data rate of the received packet flow entering the output unit exceeds the preset bandwidth value. Therefore, the excessive portion of the packet flow is discarded, and the remaining portion of the packet flow is transferred to the distribution-to-queue processing unit 32a in the next stage. When the measured value is smaller than the preset value, the received packet flow, the data rate of which does not exceed the preset bandwidth value, is transferred to the distribution-to-queue processing unit 32a.

Therefore, in the above example, a packet flow pa1-1 with a data rate of 200 Mbps, which is the difference between the measured data rate of 300 Mbps and the preset value of 100 Mbps, is discarded from the packet flow pa1 corresponding to the input number “#1,” a packet flow pa2-1 with a data rate of 200 Mbps, which is the difference between the measured data rate of 400 Mbps and the preset value of 200 Mbps, is discarded from the packet flow pa2 corresponding to the input number “#2,” and a packet flow pa3-1 with a data rate of 100 Mbps, which is the difference between the measured data rate of 500 Mbps and the preset value of 400 Mbps, is discarded from the packet flow pa3 corresponding to the input number “#3.”

Thus, the output packets Pout1 include a portion pa1-2, having a data rate of 100 Mbps, of the packet flow pa1 corresponding to the input number “#1,” a portion pa2-2, having a data rate of 200 Mbps, of the packet flow pa2 corresponding to the input number “#2,” and a portion pa3-2, having a data rate of 400 Mbps, of the packet flow pa3 corresponding to the input number “#3.”

FIG. 6 is a diagram illustrating operations for policing performed for each combination of the values of the input number and the flow number. The output-side policing unit 31 comprises a data-rate measurement unit 31a, a comparison unit 31b, and a guaranteed-bandwidth setting table T2, and performs policing based on the parameter realized by the combination of the input number and the flow number.

The input packets Pin2 are a group of packet flows which flow together and enter one of the output units after being switched by the switching unit 20. In this example, packet flows pb1, pb2, and pb3 respectively having bandwidths of 300, 400, and 500 Mbps enter the output unit, where a combination of values of the input number and the flow number is contained in the intra-device header in each packet.

When the input packets Pin2 enter the output-side policing unit 31, the data-rate measurement unit 31a measures a data rate for each combination of the values of the input number and the flow number, and obtains the data rates of 300 Mbps from the packet flow pb1 corresponding to the combination of the input number “#1” and the flow number “F1,” 400 Mbps from the packet flow pb2 corresponding to the combination of the input number “#1” and the flow number “F2,” and 500 Mbps from the packet flow pb3 corresponding to the combination of the input number “#2” and the flow number “F1.”

On the other hand, the guaranteed-bandwidth setting table T2 in the output-side policing unit 31 contains columns of the input number, the flow number, and the preset value of the guaranteed bandwidth (Mbps). For example, the guaranteed-bandwidth setting table T2 in FIG. 6 indicates that a bandwidth up to 100 Mbps is guaranteed for the packet flow corresponding to the combination of the input number “#1” and the flow number “F1,” and the guaranteed total sum of the guaranteed bandwidths is 1 Gbps.

The comparison unit 31b compares the measured value of the data rate of the packet flow corresponding to each combination of the values of the input number and the flow number with the guaranteed bandwidth value in the guaranteed-bandwidth setting table T2 corresponding to the combination. When the measured value is greater than the preset value, the data rate of the received packet flow entering the output unit exceeds the preset bandwidth value. Therefore, the excessive portion of the packet flow is discarded, and the remaining portion of the packet flow is transferred to the distribution-to-queue processing unit 32a in the next stage. When the measured value is smaller than the preset value, the received packet flow, the data rate of which does not exceed the preset bandwidth value, is transferred to the distribution-to-queue processing unit 32a.

Therefore, in the above example, a packet flow pb1-1 with a data rate of 200 Mbps, which is the difference between the measured data rate of 300 Mbps and the preset value of 100 Mbps, is discarded from the packet flow pb1 corresponding to the combination of the input number “#1” and the flow number “F1,” a packet flow pb2-1 with a data rate of 200 Mbps, which is the difference between the measured data rate of 400 Mbps and the preset value of 200 Mbps, is discarded from the packet flow pb2 corresponding to the combination of the input number “#1” and the flow number “F2,” and a packet flow pb3-1 with a data rate of 100 Mbps, which is the difference between the measured data rate of 500 Mbps and the preset value of 400 Mbps, is discarded from the packet flow pb3 corresponding to the combination of the input number “#2” and the flow number “F1.”

Thus, the output packets Pout2 include a portion pb1-2, having a data rate of 100 Mbps, of the packet flow pb1 corresponding to the combination of the input number “#1” and the flow number “F1,” a portion pb2-2, having a data rate of 200 Mbps, of the packet flow pb2 corresponding to the combination of the input number “#1” and the flow number “F2,” and a portion pb3-2, having a data rate of 400 Mbps, of the packet flow pb3 corresponding to the combination of the input number “#2” and the flow number “F1.”

Further, when the output bandwidth is substantially greater than the total sum of actually used bandwidths, the remainder of the bandwidth can be used as a surplus bandwidth. For example, the output unit can be configured so that a bandwidth exceeding the preset value can be used within the surplus bandwidth.

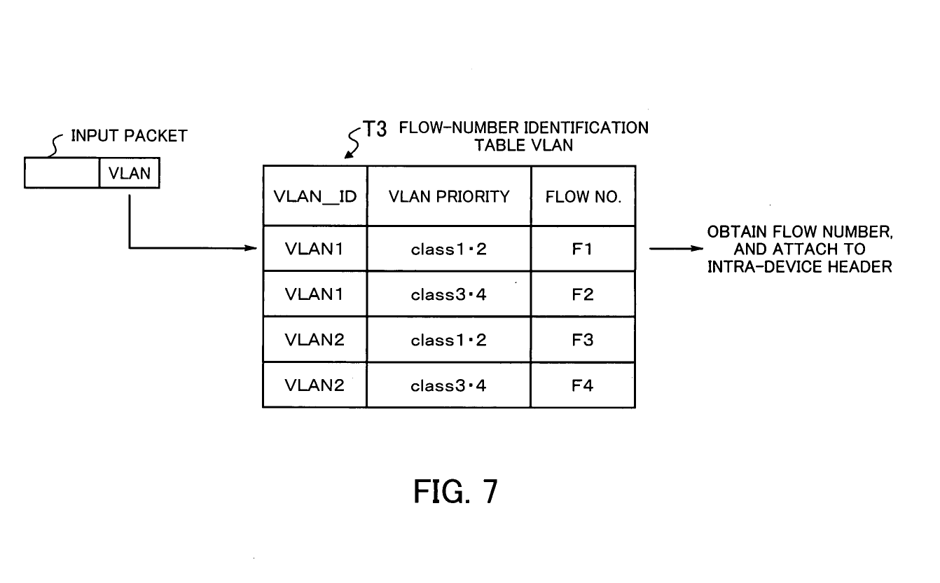

Next, a method by which the classification processing unit 11c obtains the flow number is explained below. FIG. 7 is a diagram illustrating a method for obtaining a flow number. The flow number can be defined within the device by an arbitrary combination of an ID and a priority in a VLAN tag, a MAC address, an IP address, a Layer 4 protocol, and the like. Thus, the flow number can be obtained by referring to a preset table.

FIG. 7 shows an example in which the flow number is identified by the ID and the priority in the VLAN tag. The classification processing unit 11c comprises a flow-number identification table T3, which contains columns of the VLAN_ID, the VLAN priority, and the flow number. The classification processing unit 11c identifies the flow number by referring to the VLAN tag in the received packet and the flow-number identification table T3.

For example, when the VLAN_ID in the received packet is “VLAN1,” and the priority is “class1.2,” the flow number is determined to be “F1.” The determined flow number is inserted into the received packet as the intra-device header, and used in the policing.

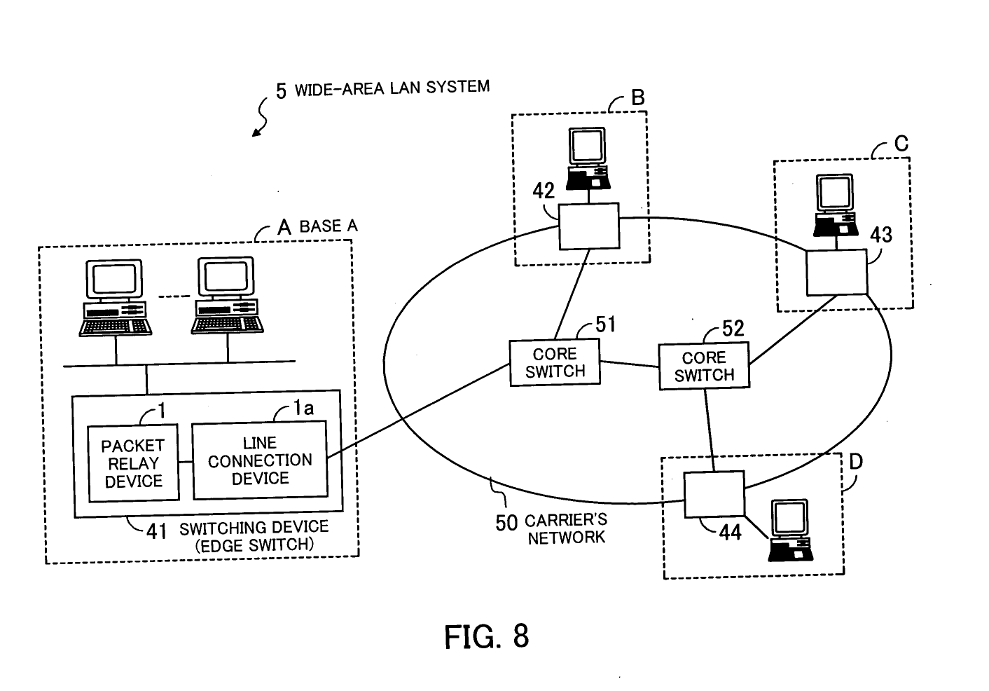

Next, a wide-area LAN system in which the packet relay device 1 according to the present invention is used is explained below. FIG. 8 is a diagram illustrating a construction of a network realizing the wide-area LAN system. In the wide-area LAN system 5 in FIG. 8, a WAN (wide area network) is constructed by connecting the bases A to D (each containing a LAN) to a carrier's network 50. For example, the wide area network is a wide-area Ethernet, and the LANs contained in the bases are Ethernet LANs.

The bases A to D are realized by LANs each of which contains a user terminal and one of the switching devices (edge switches) 41 to 44. In the base A, user terminals are bus connected, and an edge switch 41 is connected to the bus line. The terminal 41 is a switch located at a terminal end of the carrier's network 50, and realized by a line connection device (line unit) la which connects the packet relay device 1 and the carrier's network 50. Alternatively, it is possible to configure the packet relay device 1 to have the function of the line connection device 1a.

The carrier's network 50 comprises core switches 51 and 52, which are relay switches for realizing connections within the carrier's network 50. The edge switches 41 and 42 are connected to the core switch 51, and the edge switches 43 and 44 are connected to the core switch 52.

In addition, it is possible to construct a virtual communication network through the carrier's network 50 by establishing a VLAN connecting the bases. For example, it is possible to construct private networks by establishing a VLAN connecting the bases A and B, a VLAN connecting the bases C and D, and a VLAN connecting the bases A and D. When the private networks are formed as above, Ethernet frames used between the bases can be transmitted as they are. Therefore, even when the bases are remote from each other, each private network can be used as if the private network is a single LAN formed with switches. Although each of the edge switches 41 to 44 contains the packet relay device 1 in the above example, each of the core switches 51 and 52 may also contain the packet relay device 1.

As explained above, according to the present invention, the output-side policing is performed in a stage preceding the transfer of traffic to the queues in the output units, as well as the input-side policing performed in the input units, so that packet discard is performed for each input port and each communication flow when traffic confluence causes excessive traffic over the output bandwidth. Therefore, it is possible to improve an intra-device policy concerning packet discard, and provide a high-quality QoS service.

In addition, in the packet relay device according to the present invention, the input-side policing is performed on packets before being switched, and the output-side policing is performed on packets which flow together after being switched. In the output-side policing, the data rate of the packets which flow together after being switched is measured for each value of a parameter, and packets are discarded when the measured data rate exceeds a bandwidth value which is preset to be guaranteed for the value of the parameter. That is, policing is performed in the two stages. Therefore, it is possible to improve an intra-device policy concerning packet discard, and provide a QoS service with higher quality.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A packet relay device for relaying packets while guaranteeing QoS, comprising:
an input unit which performs input processing of packets;
an input-side policing unit which is included in said input unit, measures a first data rate of packets before being switched, and discards at least one of the packets before being switched, when the first data rate exceeds a first bandwidth value which is preset;
a switching unit which performs switching of the packets on which said input processing is performed;
an output unit which performs output processing of packets; and
an output-side policing unit which is included in said output unit, receives packets flowing together after being switched, measures a second data rate of a portion of the received packets corresponding to each value of a parameter, compares the second data rate with a second bandwidth value which is preset to be guaranteed for said each value of said parameter, and discards at least one packet in said portion of the received packets when the second data rate exceeds said second bandwidth value.

2. The packet relay device according to claim 1, wherein said parameter is one of a physical port number, a flow number, and a combination of the physical port number and the flow number.

3. The packet relay device according to claim 1, wherein said input unit further includes a packet-input processing unit which performs processing for at least one of,
(i) checking for validity of packets received from a network,
(ii) search for destinations of the packets received from the network,
(iii) recognition of flow numbers of the packets received from the network, and
(iv) attachment of intra-device headers to the packets received from the network, and said output unit includes a packet-output processing unit which performs processing for at least one of,
(v) distribution of the packets policed by the output-side policing unit, for enqueueing based on flow numbers the packets policed by the output-side policing unit,
(vi) queueing of the packets policed by the output-side policing unit,
(vii) scheduling for readout control of the packets policed by the output-side policing unit, and
(viii) removal of the intra-device headers from the packets policed by the output-side policing unit.

4. A switching device for relaying packets in a wide-area LAN in which the packets are transmitted between LANs through a network provided by a carrier, while guaranteeing QoS, comprising:
a line connection unit for connecting one of said LANs with said network; and
a packet relay unit which is arranged on a transmission line in said one of said LANs, performs Layer 2 switching, and includes,
an input unit which performs input processing of packets,
an input-side policing unit which is included in said input unit, measures a first data rate of packets before being switched, and discards at least one of the packets before being switched, when the first data rate exceeds a first bandwidth value which is preset,
a switching unit which performs switching of the packets on which said input processing is performed,
an output unit which performs output processing of packets, and
an output-side policing unit which is included in said output unit, receives packets flowing together after being switched, measures a second data rate of a portion of the received packets corresponding to each value of a parameter realized by one of a physical port number, a flow number, and a combination of the physical port number and the flow number, compares the second data rate with a second bandwidth value which is preset to be guaranteed for said each value of said parameter, and discards at least one packet in said portion of the received packets when the second data rate exceeds said second bandwidth value.

5. A policing method for performing policing by monitoring for excess of a packet input rate over a predetermined rate during processing for relaying packets, and discarding excessively inputted packets, comprising the steps of:
(a) performing input-side policing by measuring a first data rate of packets before being switched, and discarding at least one of the packets before being switched, when the first data rate exceeds a first bandwidth value which is preset;
(b) performing switching of said packets on which the input-side policing is performed;
(c) receiving packets which flow together after being switched, and measuring a second data rate of a portion of the received packets corresponding to each value of a parameter which is realized by one of a physical port number, a flow number, and a combination of the physical port number and the flow number; and
(d) performing output-side policing by comparing the second data rate with a second bandwidth value which is preset to be guaranteed for said each value of said parameter, and discarding at least one packet in said portion of the packets received in step (c), when the second data rate exceeds said second bandwidth value preset for said each value of said parameter.
